(19) United States
(12) Patent Application Publication
(10) Pub. No.: US 2015/0185986 A1
(43) Pub. Date: Jul. 2, 2015

(54) METHOD FOR INTEGRATED PROVISION OF ELECTRONIC BOOKS

(71) Applicant: Seung Hwan Ji, (US)

(72) Inventor: Seung Hwan Ji, Seoul (KR)

(21) Appl. No.: 14/419,932

(22) PCT Filed: Aug. 5, 2013
(86) PCT No.: PCT/KR2013/007039

§ 371 Date: Feb. 5, 2015

(30) Foreign Application Priority Data
Aug. 6, 2012 (KR) 10-2012-0085592

(51) Int. Cl. G06F 3/0483; G09B 5/02

(52) U.S. Cl. CPC G06F 3/0483; G09B 5/02

(57) ABSTRACT

Provided is a method for integrally providing electronic books. Two or more electronic books can be organically integrated by determining the relation of list items of two or more electronic books using a pre-constructed knowledge system and creating an integrated list based thereon. Thus, a learner can read two or more electronic books without a sense of difference as if the books were a single copy from the beginning, and can save time and effort which are unnecessarily wasted upon learning while comparing books which have similar contents and subjects.

### BACKGROUND OF THE INVENTION

The present invention relates to a method for integrally playing two or more electronic types of books (hereinafter, referred to as electronic books).

One single volume of textbook is often sufficient about a specific subject or theme. It is also a commonplace that two or more textbooks or auxiliary textbooks are required about the subject or theme.

In such cases, learners either borrowed from libraries or purchased several books required and learned by comparing and referring to the materials in the books chapter by chapter.

As learning contents are digitized, classic types of books gradually evolve into E-books or further-developed forms. Then, learners will borrow or purchase several volumes of electronic books and learn by comparing and referring to the materials in the books chapter by chapter in the same typical way as learners used to.

However, it causes learners very much inconvenience and take learners very much time to read all the books to extract parts in need or compare the parts, thus sometimes drastically decreasing the learning efficiency of learners.

When the contents about a specific sub-theme as presented in two or more books are almost identical, in particular, learners will suffer waste of time because they do not need to read the other identical part.

Moreover, it even takes learners unnecessarily much time merely to check what one book does not have but the other book has.

That is, even though learning materials and books are digitized, such limitations of typical technologies still remain unresolved.

Accordingly, when learning is performed by reading electronic books, there arises the need to provide some methods to improve learning efficiency by taking advantages of electronic books unlike learning through classic type of books.

### SUMMARY OF THE INVENTION

The present invention provides a method for integrally providing electronic books, which enables a learner to experience learning as if the learner read a book written into a single copy from the beginning, by organically integrating two or more electronic types of books.

Embodiments of the present invention provide methods for integrally providing electronic books, the method including: loading, by a learner terminal, at least a portion of data of two electronic books onto a memory; analyzing, by the learner terminal, each item of content lists of the two electronic books and determining a relation between a list item of one electronic book and a list item of the other electronic book; creating an integrated list using the relation between the items of the content lists of the two electronic books that are determined; and providing a user interface accessible to a relevant item of the two electronic books when the learner terminal selects any one item of the created integrated list.

In some embodiments, the determining of the relation may include: extracting keywords for each item of the content list of the two electronic books; performing mapping by determining a counterpart list item of the two electronic books among a plurality of knowledge units pertaining to the knowledge system provided from the server using the extracted keywords; and determining a relation between the list items of the two electronic books, using a predefined relation between the knowledge unit of the knowledge system corresponding to any one list item and the knowledge unit of the knowledge system corresponding to the other list item of the two electronic books, the knowledge system being created by extracting keywords from the content list of works already collected in regard to each subject, creating knowledge units that are units of learning contents repetitively appearing in regard to a relevant subject, and defining the relation between the created knowledge units from the already-collected works in regard to each subject

In other embodiments, the providing of the user interface may further include: creating a path including knowledge units mapped in each item of the created integrated list from the knowledge system provided from the server; determining whether or not there is a learning path factor reached by the path created in the knowledge system; inversely acquiring a learning path reaching the determined learning path factor from the knowledge system; and further providing a user interface accessible to learning contents of the two electronic books corresponding to knowledge units pertaining to the acquired learning path.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a view illustrating a relationship of a server, an electronic book server, and a learner terminal;

FIG. 2 is a view illustrating an exemplary knowledge system in which a plurality of knowledge units are connected in a graph structure according to mutual relations;

FIG. 3 is a table illustrating an analysis result on a plurality of knowledge units for the creation of a knowledge system;

FIG. 4 is a view illustrating a process of creating a learning plan by extracting a portion of a path on a knowledge system according to interests, learning level, and learning objective of a user;

FIG. 5 is a table illustrating a mapping result of a plurality of electronic books in a knowledge system;

FIG. 6 is a view illustrating a process of creating an integrated list using relation between two or more electronic books;

FIG. 7 is a view illustrating an exemplary user interface screen on which two or more electronic types of books are integrated and displayed;

FIG. 8 is a view illustrating a constitution principle of a user interface which enables a learner to access specific learning contents about a specific objective or subject by integrating two or more electronic types of books;

FIG. 9 is a flowchart illustrating a method for integrally providing electronic books according to an embodiment of the present invention;

FIG. 10 is a flowchart illustrating a process of setting a relation between respective items of lists of two or more electronic books in an embodiment of FIG. 9; and

FIG. 11 is a flowchart illustrating a process of deriving learning contents having a specific objective or subject using a knowledge system after creating an integrated list in an embodiment of FIG. 9.

### DETAILED DESCRIPTION OF PREFERRED EMBODIMENTS

Preferred embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

Hereinafter, exemplary embodiments of a user interface modification apparatus based on network conditions will be described in detail with reference to the accompanying drawings. In order to clarify the present invention, a description irrelevant to the constitution of the present invention will be omitted, and in the drawings, like reference numerals refer to like elements throughout.

Since the terms “comprising”, “including”, and “having” can be construed as encompassing corresponding components unless specially described as opposite, it should be understood that they do not exclude other components but encompass other components. Unless defined otherwise, all technical and scientific terms have the same meanings as commonly understood by those skilled in the art to which the present invention belongs.

In the detailed description of the invention and claims, components named as “-unit”, “-part”, “-module”, and “-block” mean units that process at least one function or operation, and each of which can be implemented by software, hardware, or a combination thereof.

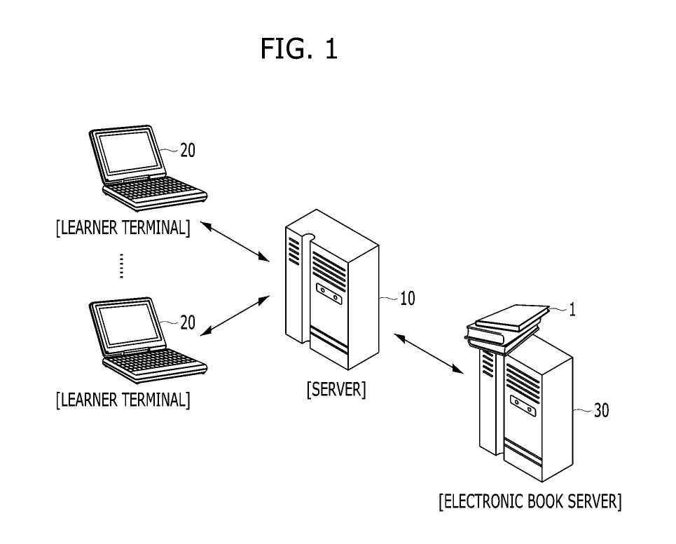

As shown in FIG. 1, a server 10 may be connected to a plurality of learner terminals 20 through a network.

In this case, the network may be an Internet network. The learner terminal 20 may be a unit for playing and displaying an electronic type of book (hereinafter, referred as electronic book) 1, and may be connected to the server 10 via the network.

Accordingly, the type of the learner terminal 20 may include typical apparatuses such as personal computers, smart phones, and tablets, or may be an exclusive terminal for playing a new electronic book 1 such as digital textbook, which is expected to emerge in the near future.

An electronic book server 30 may store the electronic books 1, and may provide the electronic books 1 to the server 10 or the learner terminal 20 through the network. The electronic book server 30 may include electronic library or Internet bookstores having an electronic book database.

The server 10 may create and store a knowledge system, and may acquire and analyze the electronic book 1 such as E-books from the electronic book server. The server 10 may further collect information interests or learning levels of learners from the plurality of learner terminals 20 connected through the network.

The method for integrally providing electronic books according to the embodiment may be executed in the user terminal 20.

Prior to detailed description of the method for integrally providing electronic books according to the embodiment, terms used herein will be defined as follows.

The term “electronic book 1” denotes data in which texts, images, and multimedia contents are combined according to certain order and list, and which can be transmitted through a network or can be stored or copied in a recordable medium such as a flash memory or a DVD.

Such electronic book 1 may be played in the learner terminal 20. All or at least a portion of contents included in the electronic book 1 may be downloaded into the learner terminal 20 or may be played while being stored in a local storage. That is, a portion of contents included in the electronic book 1 may also be provided in real-time while the learner terminal 20 is being connected in on-line state to a separate server 30 hosting the corresponding contents when necessary.

Meanwhile, the electronic book 1 may include a plurality of learning contents which are organically combined with each other in an inseparable form.

The combining into the inseparable form may mean finally encoding as a whole even though materials are written using files stored by unit of page, or considering technical measures such as DRM such that only a portion of contents cannot be distributed and copied by ordinary methods.

The electronic book 1 may include existing E-books and may further include other types evolved from E-books as long as meeting the foregoing definitions.

For example, the electronic book 1 may include digital textbooks under discussion.

The term “knowledge system” may be a structure defining relations of a plurality of knowledge units about a relevant subject. The knowledge unit pertaining to each knowledge system may be expressed as a graph structure according to the relation thereof.

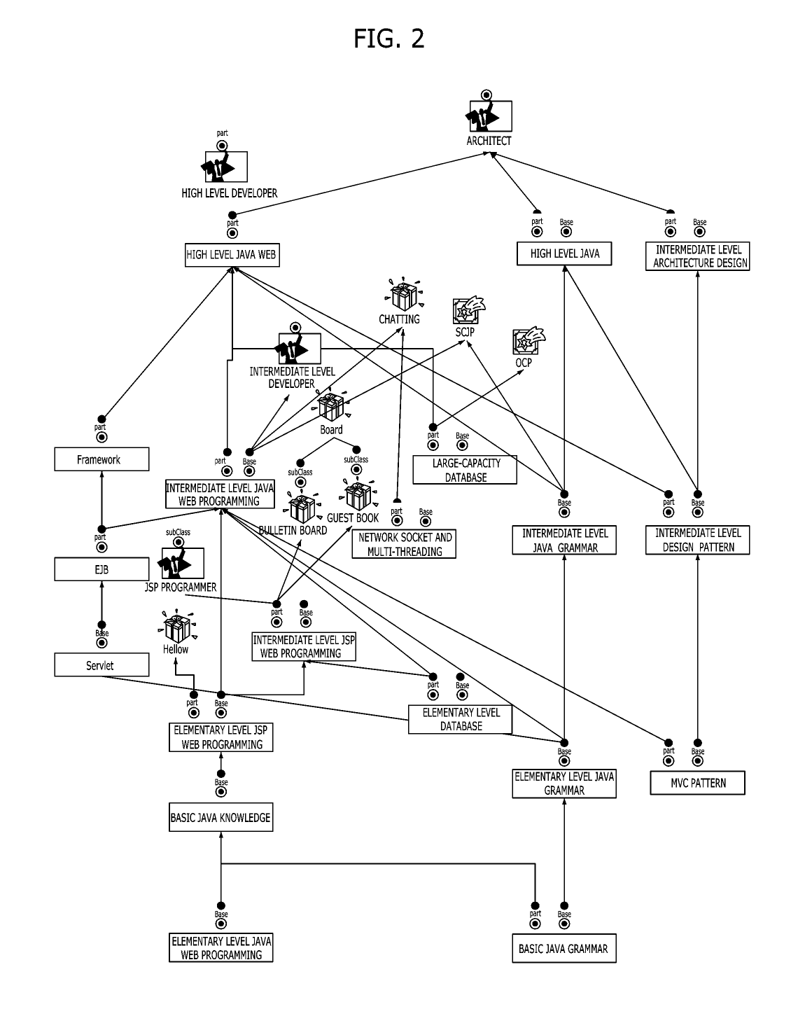

FIG. 2 exemplifies a knowledge system about “JAVA programming”.

In the knowledge system exemplified in FIG. 2, a plurality of knowledge units become nodes, and edges connecting the respective nodes represent relations between nodes at the both sides of each edge.

As shown in FIG. 2, the knowledge units named, e.g., “basic JAVA web programming”, “basic Java grammar”, “basic JSP knowledge”, “elementary level JAVA web programming”, “elementary level Java grammar”, “elementary level database’, “MVC pattern”, and “servlet’ from the bottom form the nodes.

The relation between the knowledge units may be divided into a precedence relation, an inclusion relation, and an equivalence relation.

The precedence relation means that one knowledge unit precedes the other knowledge unit when precedence learning about the other knowledge unit is needed to learn one knowledge unit.

As shown in FIG. 2, “basic JSP knowledge” precedes “elementary level JAVA web programming”, and “elementary level JAVA web programming” precedes “intermediate level JAVA web programming”.

The term “base” is marked at the edge connecting two knowledge units, and means the precedence relation.

Meanwhile, “high level JAVA web programming” has an inclusion relation with respect to “Framework” and “Large-capacity database”, i.e., includes “Framework” and “Large-capacity database”. Also, “high level JAVA web programming” is connected to “intermediate level JAVA web programming” as a precedence relation requiring precedence learning.

The term “part” is marked at the edges connecting relevant knowledge units, and means the inclusion relation.

Although not shown in FIG. 2, the equivalence relation means that two or more knowledge units can be replaced with each other.

For example, since “elementary level JAVA web programming” and “basic JAVA script” are formed of learning contents which have the substantially same contents and difficulty, they are in the equivalence relation in which they can be replaced with each other.

Thus, the knowledge system represents relationships between knowledge units in regard to a specific subject, and may be expressed as a graph structure.

The knowledge system may be beforehand formed for each subject (e.g., “JAVA programming”, “Tenth grader mathematics”, “C language”, “World history”, etc.), and may also be complemented whenever a new work or curriculum is made in regard a relevant subject.

Meanwhile, the knowledge system shown in FIG. 2 may further include a learning path factor in addition to the nodes indicating the knowledge units and the edges indicating the relationship of the knowledge units.

The learning path factor is a node existing at the uppermost location of the knowledge system (that is, has only child nodes, not parent nodes). The learning path factor defines the nature of a learning path (at least a portion thereof) from the lowest node to the corresponding node.

For example, the highest node of the graph structure shown in FIG. 2 may include nodes indicated as “high level developer”, “architect”, and “intermediate level developer”. The paths of the knowledge units (all or a portion thereof) from the lowest node of the graph structure to the corresponding node, i.e., the learning path factor may become a learning plan to learn in order to become “high level developer”, a learning plan to learn in order to become “architect”, and a learning plan to learn in order to become “intermediate level developer”, respectively.

The learning path factor may be divided into various types in accordance with contents.

For example, the learning path factor may be divided into learning objective, learning activity, obtainment of certificate, and the like.

As shown in FIG. 2, the highest nodes of the graph structure are indicated as “high level developer”, “architect”, “intermediate level developer”, and “JSP programmer” and all may correspond to “learning objective”.

That is, in order to achieve a corresponding learning objective, the respective knowledge units on the path from the lowest node of the knowledge system to the corresponding learning path factor need to be learned as shown in FIG. 2.

As shown in FIG. 2, “bulletin board”, “guest book”, and “chatting” may be indicated on the highest node of the graph structure, and each may correspond to “learning activity”.

All learners do not have to learn JAVA programming in order to become a high level developer or an architect. Some learners may merely want to code the bulletin board or the guest book using JAVA.

As shown in FIG. 2, various “learning activities” may be indicated on the knowledge system. A path to the corresponding learning activity on the knowledge system may include contents that a learner needs to learn in order to manufacture “bulletin board”, “guest book”, and “chatting window” using JAVA, respectively.

As shown in FIG. 2, “SCJP” and “OCP” may be indicated on the highest node of the graph structure, and each may correspond to “certificate”.

The path to “certificate” on the knowledge system describes contents that a learner needs to learn in order to obtain the corresponding certificate.

The term “knowledge unit” is a unit of learning contents corresponding to the node of the knowledge system, and may correspond to a sub-theme related to a specific subject.

For example, the subject of the knowledge system is “JAVA programming”, there may be sub-themes such as “basic JAVA web programming “basic JAVA grammar”, “basic JSP knowledge”, “elementary level JAVA web programming”, and “elementary level Java grammar” in regard to the corresponding subject.

The knowledge unit may frequently and repetitively appears through a considerable number of works related to the corresponding subject.

For example, when there is a unit corresponding to “JAVA web programming” or “basic Java grammar” in most JAVA programming books for beginners, the unit may occupy one node on the knowledge system.

As another example, there are units such as “statistics” and “differential and integral calculus” in most books about “tenth grader mathematics”, the units may occupy nodes as one knowledge unit in the “tenth grader mathematics” knowledge unit.

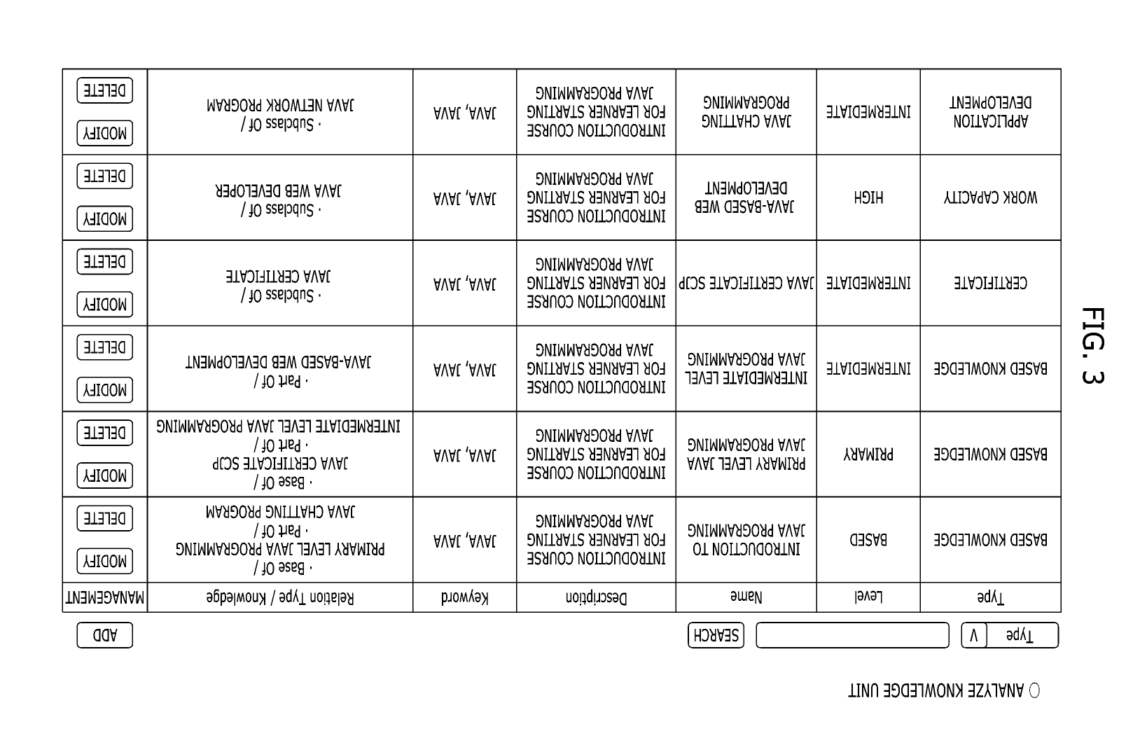

FIG. 3 is a table illustrating an analysis result on a plurality of knowledge units for the creation of a knowledge system.

The “name” may be assigned for the unit of learning contents repetitively appearing based on a specific subject, and “description” may be described, and then “keyword”, “level”, and “type” may be set to create a knowledge unit as shown in FIG. 3.

The name and keyword of the knowledge unit may be obtained from the tables of contents of books (in this case, including a classic type of books) related to the corresponding subject, and the description may be made by summarizing the contents of the relevant unit of the books.

The level may be information that can be added in order to determine whether or not the learning level is suitable for a learner, and the type may correspond to information that can be added in order to determine whether or not the learning objective is suitable for a learner.

Meanwhile, “learning unit” may be a basic unit of learning contents included in each knowledge unit. The learning unit may not repetitively appear in works related to the corresponding subject.

For example, although there is a unit corresponding to “JAVA web programming” in most JAVA programming books for beginners, the respective books may differ in description, example sentence, or quiz of a relevant unit.

That is, the learning unit may be learning contents included in the knowledge unit, and may mean what may not repetitively appear in works related to the corresponding subject. Accordingly, the learning unit cannot occupy the position of node in the knowledge system.

The term “mapping” means a process of dividing the table of contents of the electronic book 1 into a plurality of knowledge units and selecting a counterpart from the knowledge unit pertaining to the knowledge system that is already created with respect to each knowledge unit.

In addition, although the term “learning contents” is used, this is a general term, and denotes data manufactured into a form of text, image, or other multimedia, which are manufactured for the purpose of learning. In this embodiment, the learning contents are not used as a term over a layer corresponding to the “unit” such as knowledge unit or learning unit.

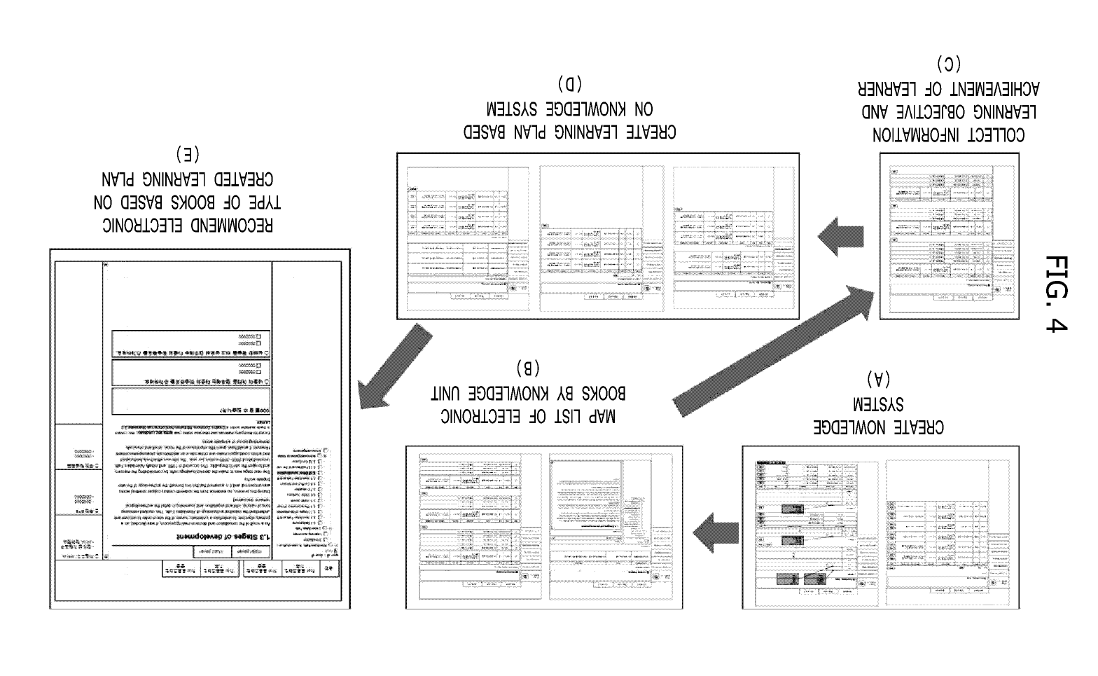

Hereinafter, a method for integrally providing electronic books according to an embodiment of the present invention will be described using the foregoing terms with reference to FIGS. 4 to 11.

FIG. 4 is a view illustrating a process of creating a learning plan by extracting a portion of a path on a knowledge system according to interests, learning level, and learning objective of a user. A method for managing electronic books through mapping of the knowledge system according to an embodiment of the present invention may correspond to a portion of the whole process shown in FIG. 4.

As shown in FIG. 4A, the knowledge units may be created through the process described in FIGS. 2 and 3, and the relation of the created knowledge units may be established to build the knowledge system.

Thereafter, as shown in FIG. 4B, electronic books 1 that are available may be mapped in the knowledge system that is already built.

Next, as shown in FIG. 4C, information on interests, learning level, and learning objective of a learner may be collected.

Next, as shown in FIG. 4D, a learning plan may be created using the knowledge system.

Finally, as shown in FIG. 4E, electronic books 1 that correspond to the learning plan may be recommended.

A learner may select at least one of electronic books 1 necessary for himself/herself from a plurality of electronic books 1 that are recommended, and may read the selected books in an integrated form.

The method for managing the electronic book through knowledge system mapping according to the embodiment may correspond to a process of selecting and renting or purchasing, by a learner, at least one electronic book 10 and then reading the book 10.

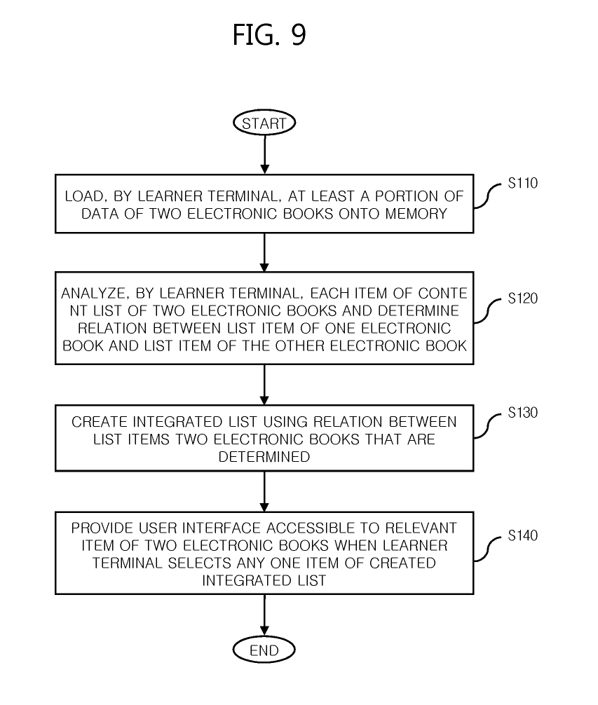

FIG. 9 is a flowchart illustrating a method for integrally providing electronic books according to an embodiment of the present invention.

As shown in FIG. 9, when a learner selects and purchases or rents two or more electronic books from a plurality of electronic books 1 which are recommended (i.e., mapped in the same knowledge system) in regard to the same subject, the learner terminal 20 may download and store the two or more electronic books 1 in a local storage.

The learner terminal 20 may provide two or more electronic books 1 to a learner by integrating the two or more electronic books 1 through the following process such that a learner can experience learning as if a learner reads only one electronic book 1.

Hereinafter, two electronic books 1 are described as being integrated, but this is to help the understanding of the present invention. For example, the same process can be applied to integration of three or more electronic books 1.

First, the learner terminal 20 may load at least a portion of data of two electronic books 1 to be integrated according to the selection of a learner onto a memory (S110).

Next, the learner terminal 20 may analyze respective items of the content list of the two electronic books 1, and may determine a relation between the list item of one electronic book 1 and the list item of the other electronic book 1 (S120).

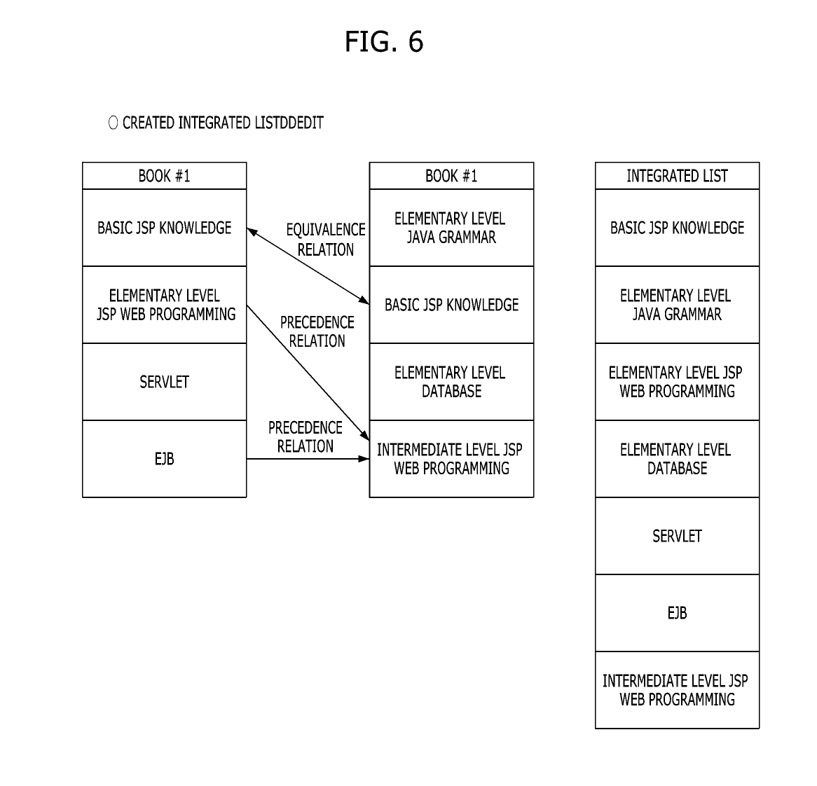

Thus, when the relation between the respective list items of the two electronic books 1 is determined, an integrated list may be created using the relation as exemplified in FIG. 6.

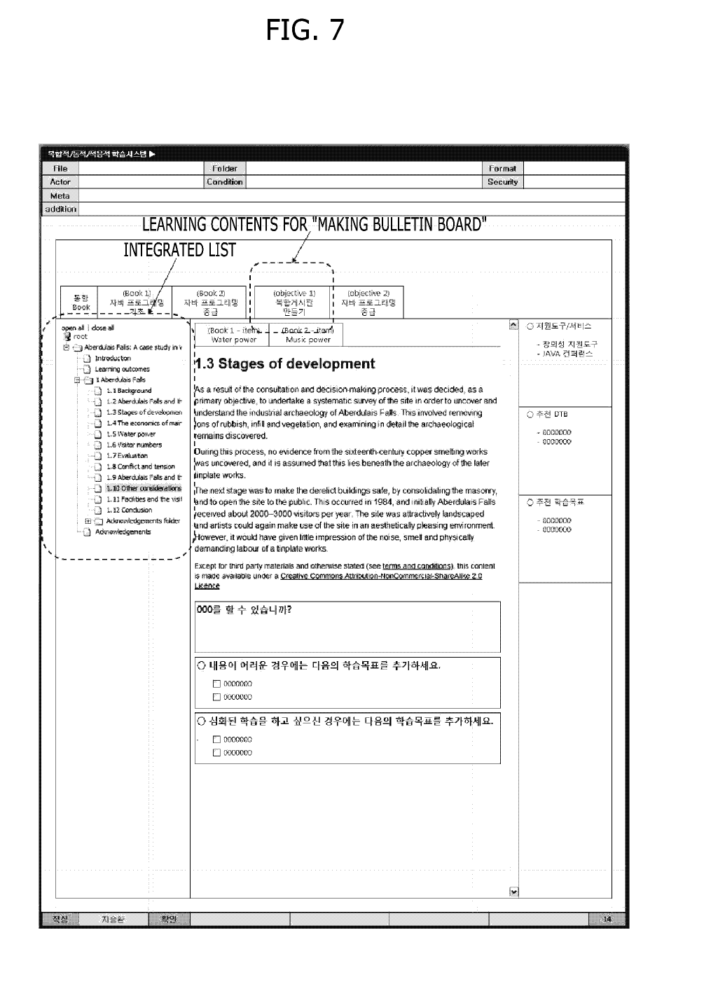

Thereafter, as exemplified in FIG. 7, the integrated list may be provided through a user interface displayed on the screen of the learner terminal 20.

Accordingly, a learner may select a list item to learn using the integrated list as shown in FIG. 7, and may directly access the corresponding learning contents of the corresponding electronic book 1 when the list item is selected.

The integrated list may allow a learner to experience learning as if a learner reads just one electronic book 1 by organically integrating the respective items of the content list of the two or more electronic books 1 in accordance with a process described later.

The relation between the list items of two electronic books 1 determined in operation S120 may mean whether or not any one of the list items of one book precedes any one of the list items of the other book, whether or not any one of the list items of one book includes any one of the list items of the other book, or whether or not any one of the list items of one book can be replaced with any one of the list items of the other book, that is, whether or not the two books are in an equivalence relation.

Meanwhile, in operation S120, a method of determining the relation between the list items of two electronic books 1 may be defined as the following two kinds.

First, the relation of the list items of two electronic books 1 may be determined by receiving the mapping results about each knowledge system of the two electronic books 1 from the server 10.

For a better understanding of the present invention, a process of building the knowledge system by the server 10 and mapping the electronic book 1 will be further described.

The server 10 may create a knowledge unit from the content list of the works related to a specific subject that is already collected. In this case, works related to a specific subject may include a classic type of books as well as electronic books such as E-books.

Meanwhile, the collection of works related to a specific subject may be performed by a worker, and thus will not fall within the scope of the present invention.

In case of electronic book, content list data may be drawn and parsed, and then may be analyzed by a certain algorithm. Also in case of classic type of books, if a worker converts the content list into an image file and then reconverts the image file into a text, the text may be analyzed by a certain algorithm.

Upon creation of the knowledge unit, the content list (or sub-list) of the relevant work itself may be used as the name of the knowledge unit. Also, the classification (e.g., “JAVA programming” and “JAVA grammar”), difficulty (e.g., “basic”, “elementary level, and “intermediate level”), and type (e.g., “textbook”, “certificate”, and “actual practice”) of the relevant book may be determined through the keyword analysis of the content list or contents of the book, respectively.

Meanwhile, if necessary, a worker may complement the knowledge unit created by the server 10 such that the knowledge unit become more precise and accurate as exemplified in FIG. 3.

Thereafter, the server 10 may determine the relation between the created knowledge units using the content list of works that are already collected in regard to each subject.

That is, it may be determined from the content list of the already-collected works whether or not one knowledge unit precedes another knowledge unit.

Or, it may be determined whether or not one knowledge unit includes another knowledge unit.

Or, it may be determined whether or not one knowledge unit is in the equivalence relation with another knowledge unit.

According to such determination results, the relations between the knowledge units may be determined.

Thereafter, the server 10, as shown in FIG. 2, may create a graph structure in which the generated knowledge units become nodes, and the relations between the knowledge units become edges.

As described above, the generated graph structure corresponds to the knowledge system.

As described above, the knowledge system may further include the learning path factor, as a node existing at the highest location of the knowledge system, which defines the characteristics of the learning path from the lowest node to the corresponding node. The server 10 may analyze the common features of the knowledge units pertaining to the path from the lowest node of the created graph structure to other nodes

For example, when all of the knowledge units corresponding to a specific path relate to “certificate”, a learning path factor having name/attribute of “certificate” may be set by creating a new node over the highest node (in this case, the highest node is merely the highest node on a specific path, and may not be the highest structure of the graph) of the corresponding path.

In FIG. 2, it can be verified that the nodes such as “SCJP” and “OCP” exist.

Or, when the knowledge units corresponding to a specific path relate to “JAVA web programming” and gradually increase from the lowest level at the lowest node to the intermediate level in difficulty, a new node may be created over the highest node of the corresponding path to set a learning path factor having name/attribute of “intermediate level JAVA web programming”.

In FIG. 2, it can be verified that the node indicated as “intermediate level development” exists around the middle of the graph.

Through the foregoing process, the knowledge system as exemplified in FIG. 2 may be established in regard to a specific subject.

The establishing process of the knowledge system may be repetitively performed on various subjects.

However, the knowledge system may be established with respect to learning contents having characteristics that reading or learning needs to be conducted according to a certain order, and thus may not be applied to books such as novels or essays in which the learning order does not exist.

The knowledge system may be mainly established with respect to learning contents related to learning.

Thus, when the knowledge system is established, the server 10 may analyze the electronic book 1 obtained through the network in order to extract knowledge units, and may map the knowledge units in the established knowledge system.

For this, the server 10 may read out the content list of the electronic book 1, and may extract keywords for each item of the content list.

Also, the server 10 may determine a counterpart list item of the electronic book 1 among a plurality of knowledge units pertaining to the established knowledge system using the extracted keywords and may perform mapping.

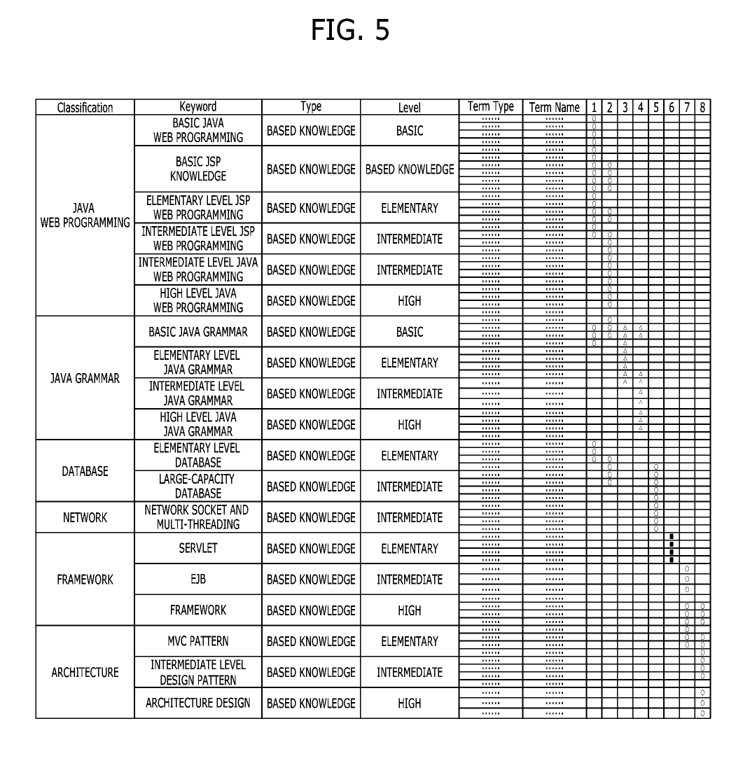

FIG. 5 is a table illustrating a mapping result through the foregoing process.

The numbers 1 to 8 at the right side of FIG. 5 denote electronic books 1 about the subject “JAVA programming”, respectively.

Also, “basic JAVA web programming”, “basic JSP knowledge”, “elementary level JAVA web programming”, and the like denote knowledge units pertaining to the knowledge system that is already established.

Meanwhile, the symbols O and ▴ under the numbers at the right side of FIG. 5 may denote results marked after determining whether the list item of the electronic book 1 corresponds to the knowledge unit, respectively.

The symbol O means that mapping is accurately perform in a specific knowledge unit of the knowledge system, and the symbol ▴ means that mapping has been performed by an algorithm but the accuracy of mapping is lower than a certain value.

A portion where the symbol O or ▴ is absent means that mapping is not performed.

As shown in FIG. 5, in an electronic book 1 No. 1, mapping is performed to “basic JAVA web programming”, “basic JSP knowledge”, “elementary level JSP web programming”, and “intermediate level JSP web programming”.

However, mapping is not performed in “intermediate level JAVA web programming” and “high level JAVA web programming”.

On the other hand, in an electronic book No. 2, it can be seen that mapping is performed on a portion of “basic JSP knowledge” and is also performed on “intermediate level JAVA web programming” and “high level JAVA web programming” on which mapping is not performed in the electronic book No. 1.

When mapping is performed on the electronic books 1 through the foregoing process, the server 10 may reconstruct and store the content list of each electronic book 1 into a form where mapped knowledge units are sequentially connected.

That is, the content list of the electronic book 1 No. 1 may be separately stored as including “basic JAVA web programming”->“basic JSP knowledge”->“elementary level JSP web programming”->“intermediate level JSP web programming”, and the content list of the electronic book 1 No. 2 may be separately stored as including “basic JSP knowledge”->“intermediate level JAVA web programming”->“high level JAVA web programming”.

The learner terminal 20 may be provided with the mapping result that the server 10 performs in advance in the knowledge system with respect to the two electronic books 1. Since each item of the content list of the electronic book 1 is mapped in the knowledge unit of the knowledge system, respectively, the list item of each electronic book 1 may be restored to the knowledge unit.

That is, the list items of the two electronic books 1 may each have a location on the knowledge system indicated as the graph structure as shown in FIG. 2.

Accordingly, a relation between any one list item of one electronic book 1 and any one list item of the other electronic book 1 may be replaced with a relation between a knowledge unit corresponding to any one list item of one electronic book 1 and a knowledge unit corresponding to any one list item of the other electronic book 1.

Accordingly, by the medium of the knowledge system, the relation between the list items of two electronic books 1 can be determined.

FIG. 6 illustrates a process of determining a relation between list items of two electronic books 1 and creating an integrated list using the relation.

When the list item of one electronic book 1 and the list item of the other electronic book 1 are in an equivalence relation, any one may be excluded from the integrated list, or may be together included in the same location of the content list as a sub-list.

On the other hand, when the list item of one electronic book 1 and the list item of the other electronic book 1 are in a precedence relation, any one item may precede the other item in the integrated list.

Meanwhile, in case of inclusion relation, any one item may be included as a sub-list in the other item of the integrated list.

In another method of determining the relation between the list items of two electronic books 1, the learner terminal 20 may receive the knowledge system from the server 10, and may directly determine the relation.

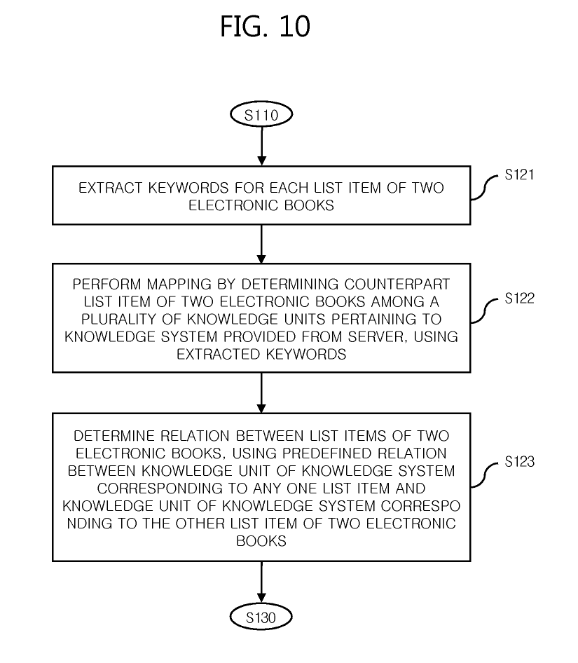

FIG. 10 is a flowchart illustrating a process of setting a relation between respective items of content list of two or more electronic books in an embodiment of FIG. 9, a detailed description of which will be made below.

As shown in FIG. 10, the learner terminal 20 may extract keywords for each item of the content list of the two electronic books 1 (S121).

Next, a counterpart list item of the two electronic books 1 may be determined among a plurality of knowledge units pertaining to the knowledge system provided from the server 10 using the extracted keywords and thus mapping may be performed (S122).

Finally, a relation between the list items of the two electronic books 1 may be determined using a predefined relation between the knowledge unit of the knowledge system corresponding to any one list item and the knowledge unit of the knowledge system corresponding to the other list item of the two electronic books 1 (S123).

When the relation between the list items of two electronic books 1 is determined through the foregoing process, the learner terminal 20 may integrate each item of the content list of the two electronic books 1, and may create an integrated list by rearranging the items as exemplified in FIG. 6 in accordance with the relation between the items.

Meanwhile, in the method for integrally providing electronic books according to the embodiment, learning contents included in two electronic books 1 may not be only organically integrated by integrating the content lists of two or more electronic books 1 to create the integrated list, but synergy according to the integration of two electronic books 1 can also be expressed in a typical form.

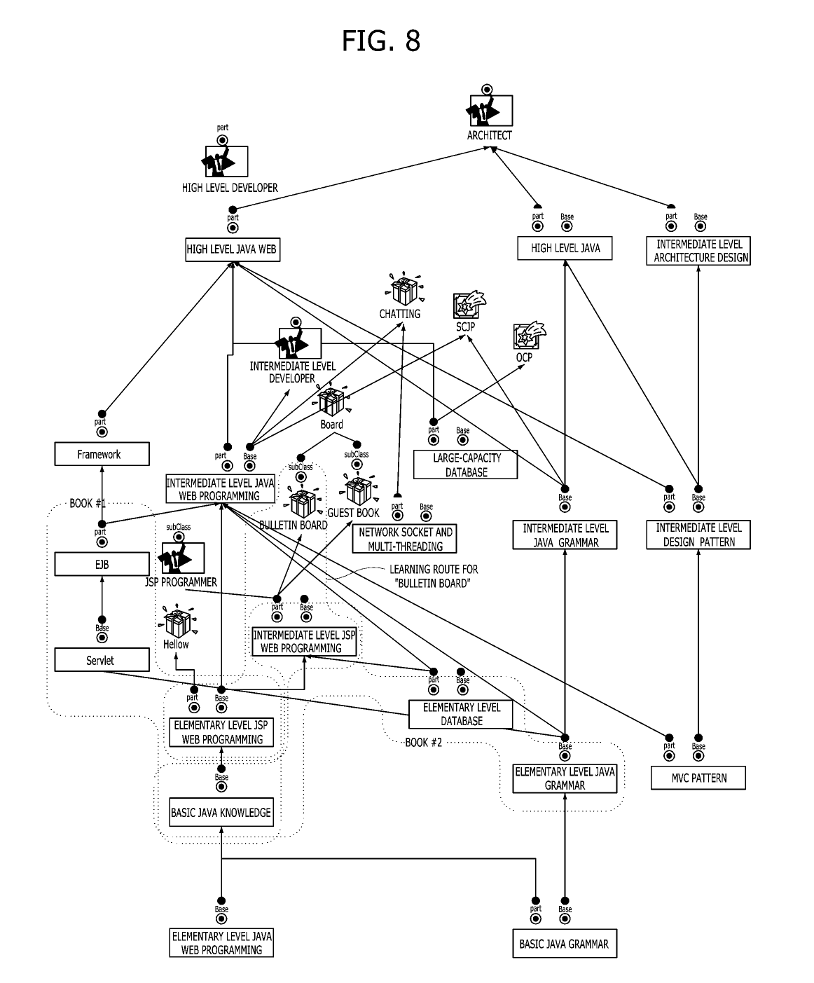

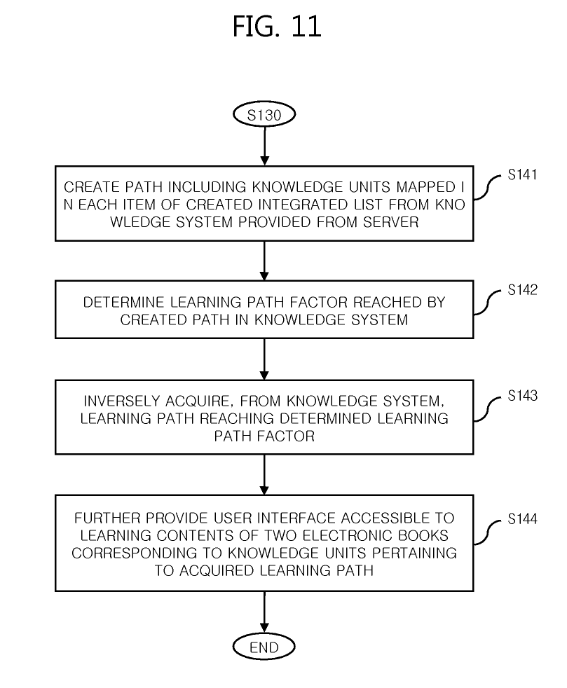

This can be understood by referring to FIGS. 8 and 11.

FIG. 8 is a view illustrating a constitution principle of a user interface which enables a learner to access specific learning contents about a specific objective or subject by integrating two or more electronic books, and FIG. 11 is a flowchart illustrating a process of deriving learning contents having a specific objective or subject using a knowledge system after creating an integrated list in an embodiment of FIG. 9.

As shown in FIG. 8, the knowledge units each mapped in the list item of one electronic book 1 and the knowledge units each mapped in the list item of the other electronic book 1 may be visually verified.

In FIG. 8, it can be seen that the node “bulletin board”, i.e., a learning path factor which cannot be reached by paths of the knowledge units mapped in each of electronic books 1 can be reached by a combined path of the knowledge units mapped in each list item of the two electronic books 1.

That is, learning contents corresponding to “bulletin board” that is a learning path factor may not be sufficiently provided by any one of electronic books 1, but a synergy that sufficiently provides a bundle of learning contents about an exercise for coding a bulletin board with JAVA may be generated by the integration of two electronic books 1.

In this case, the knowledge units pertaining to a path defined by the node “bulletin board” that is a learning path factor under the knowledge system as shown in FIG. 2 may mean a bundle of learning contents about an exercise for coding a bulletin board with JAVA.

Accordingly, when there is a learning path factor on the knowledge system which is newly reached in accordance with the integration of the electronic books 1, the learner terminal 20 may enable a learner to directly access the learning contents of the electronic books 1 each corresponding to the knowledge units pertaining to the path defined by the learning path factor by combining the learning contents of the electronic books 1.

To again describe such process in terms of the learner terminal 20, as shown in FIG. 11, the learner terminal 20 may create a path including knowledge units mapped in each item of the created integrated list from the knowledge system provided from the server 10 (S141).

The created path may be identical to a combination of the knowledge units mapped in two electronic books 1 of FIG. 8.

In this case, it may be determined whether or not there is a learning path factor reached by the path created in the knowledge system as shown in FIG. 8 (S142).

When there is a learning path factor reachable at last by the integration of books like “bulletin board” in FIG. 8, the learner terminal 20 may inversely acquire a learning path reaching the determined learning path factor from the knowledge system (S143).

That is, the learning path defined by the learning path factor may be acquired from the knowledge system as shown in FIG. 2.

Thereafter, the learning contents of the two electronic books 1 corresponding to the knowledge units pertaining to the acquired learning path may be bundled into one, and thus as exemplified in an upper portion of FIG. 7, a learner may be allowed to directly access the learning contents through a user interface displayed on the screen of the learner terminal 20 (S144).

Accordingly, when desiring to code a bulletin board with JAVA, a learner, as exemplified in FIG. 7, may directly access the relevant learning contents via a menu provided through a separate user interface instead of directly searching for and looking through relevant contents through the integrated list or the content list of each electronic book 1.

This can be construed as corresponding to a separate content list separated from the integrated list.

That is, a new content list that does not exist in the constitution of the content list of each electronic book 1 may be created based on the knowledge system.

Meanwhile, the method of integrally providing electronic books according to the embodiment of the present invention can also be embodied as computer readable codes on a computer readable recording medium.

In this case, the computer readable recording medium is any data storage device that can store data which can be thereafter read by a computer system. Examples of the computer readable recording medium include DVD-read only memories (DVD-ROMs), CD-ROMs, hard disks, USB memories, and flash memories.

Meanwhile, the expression, ‘stored in a recording media’ does not compass only a case where contents are stored in recording media in mass quantity and distributed in a form of package, but also a case where contents are stored in recording media through a network in a form of data packet.

Two or more electronic books can be organically integrated by determining the relation of list items of two or more electronic books using a pre-constructed knowledge system and creating an integrated list based thereon.

Thus, a learner can read two or more electronic books without a sense of difference as if the books were a single copy from the beginning, and can save time and effort which are unnecessarily wasted when learning while comparing books which have similar contents and subjects.

Furthermore, the combination of learning contents about specific subject and purposes, which cannot be provided in a single copy by integrating two or more electronic books, can be newly derived in light of the knowledge system. Thus, an intuitive user interface that can be directed accessed can be further provided.

The above-disclosed subject matter is to be considered illustrative and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method for integrally providing electronic books, the method comprising:
loading, by a learner terminal, at least a portion of data of two electronic books onto a memory;
analyzing, by the learner terminal, each item of content lists of the two electronic books and determining a relation between a list item of one electronic book and a list item of the other electronic book;
creating an integrated list using the relation between the items of the content lists of the two electronic books that are determined; and
providing a user interface accessible to a relevant item of the two electronic books when the learner terminal selects any one item of the created integrated list.

2. The method of claim 1, wherein the determining of the relation comprises determining:
whether or not any one of the list items of one book precedes any one of the list items of the other book;
whether or not any one of the list items of one book comprises any one of the list items of the other book; or
whether or not any one of the list items of one book is replaceable with any one of the list items of the other book, that is, whether or not the two books are in an equivalence relation.

3. The method of claim 1, wherein in the determining of the relation, the relation between the list items of the two electronic books is determined by receiving mapping results about each knowledge system of the two electronic books from the server;
the knowledge system being created by extracting keywords from the content list of works already collected in regard to each subject, creating knowledge units that are units of learning contents repetitively appearing in regard to a relevant subject, and defining the relation between the created knowledge units from the already-collected works in regard to each subject; and
the mapping being performed by determining a counterpart of a plurality of knowledge units pertaining to the knowledge system with respect to each item of the content list of the electronic book about the same subject as the knowledge system.

4. The method of claim 3, wherein in the determining of the relation, the relation between the list items of the two electronic books is determined using a predefined relation between the knowledge unit of the knowledge system corresponding to any one list item and the knowledge unit of the knowledge system corresponding to the other list item of the two electronic books.

5. The method of claim 1, wherein the determining of the relation comprises:
extracting keywords for each item of the content list of the two electronic books;
performing mapping by determining a counterpart list item of the two electronic books among a plurality of knowledge units pertaining to the knowledge system provided from the server using the extracted keywords; and
determining a relation between the list items of the two electronic books, using a predefined relation between the knowledge unit of the knowledge system corresponding to any one list item and the knowledge unit of the knowledge system corresponding to the other list item of the two electronic books,
the knowledge system being created by extracting keywords from the content list of works already collected in regard to each subject, creating knowledge units that are units of learning contents repetitively appearing in regard to a relevant subject, and defining the relation between the created knowledge units from the already-collected works in regard to each subject.

6. The method of claim 1, wherein in the creating of integrated list, each item of the content lists of the two electronic books that are determined is integrated, and is rearranged in accordance with the relation between the items to create the integrated list.

7. The method of claim 1, wherein in the providing of the user interface, when any one item of the respective content list of the two electronic books and the integrated list is selected, the learner terminal determines an electronic book corresponding to the selected item, and displays relevant learning contents of the corresponding electronic book.

8. The method of claim 1, wherein the providing of the user interface further comprises:
creating a path comprising knowledge units mapped in each item of the created integrated list from the knowledge system provided from the server;
determining whether or not there is a learning path factor reached by the path created in the knowledge system;
inversely acquiring a learning path reaching the determined learning path factor from the knowledge system; and
further providing a user interface accessible to learning contents of the two electronic books corresponding to knowledge units pertaining to the acquired learning path.
